(19) United States
(12) Patent Application Publication
(10) Pub. No.: US 2025/0227567 A1
(43) Pub. Date: Jul. 10, 2025

(54) METHOD AND APPARATUS FOR UPDATING DUAL-CONNECTIVITY TERMINAL DEVICE CELL GROUPS

(71) Applicant: Beijing Xiaomi Mobile Software Co., Ltd., Beijing (CN)

(72) Inventors: Yumin WU, Beijing (CN); Yi XIONG, Beijing (CN)

(73) Assignee: Beijing Xiaomi Mobile Software Co., Ltd., Beijing (CN)

(21) Appl. No.: 18/853,757

(22) PCT Filed: Apr. 8, 2022
(86) PCT No.: PCT/CN2022/085969

§ 371 Date: Oct. 3, 2024

(51) Int. Cl. H04W 36/00; H04W 36/08

(52) U.S. Cl. CPC H04W 36/0069; H04W 36/0064; H04W 36/08

(57) ABSTRACT

Disclosed in embodiments of the present disclosure is a method and apparatus for updating dual-connectivity (DC) terminal device cell groups, which can be applied to the technical field of communication. The method executed by a source secondary node (SN) comprises: sending a cell movement process request message to a target node, wherein the request message is used for instructing the target node to prepare a target candidate secondary cell group (SCG) for the DC terminal device, and the target node is a target SN or a source master node (MN) (201). When the DC terminal device satisfies a cell movement process, the source SN sends the cell movement process request message to the source MN or the target SN; by means of the negotiation between network nodes, a terminal supporting DC can execute a “conditional trigger-based mobility process” or “selective activation cell group process” on an MCG and an SCG at the same time, so that the reliability of a terminal mobility process is improved.

### CROSS-REFERENCE TO RELATED APPLICATION

The present application is a National Stage of International Application No. PCT/CN2022/085969, filed on Apr. 8, 2022, the entire disclosure of which is incorporated herein by reference for all purposes.

### TECHNICAL FIELD

The present disclosure relates to the field of communication technology, and in particular to a method and an apparatus for updating a cell group of a dual connectivity terminal device.

### BACKGROUND

A Dual Connectivity (DC) terminal device can access two cell groups, i.e., a master cell group (MCG) and a secondary cell group (SCG). The MCG corresponds to a network side Master Node (MN), and the SCG corresponds to a network side Secondary Node (SN).

### SUMMARY

Embodiments of the present disclosure provide a method and an apparatus for updating a cell group of a dual connectivity terminal device.

In a first aspect, embodiments of the present disclosure provide a method for updating a cell group of a dual connectivity terminal device, performed by a source secondary node, the method including:
sending a cell mobility procedure request message to a target node, wherein the request message is configured to instruct the target node to prepare a target candidate secondary cell group SCG for the dual connectivity terminal device, the target node is a target secondary node or a source master node.

In a second aspect, embodiments of the present disclosure provide a method for updating a cell group of a dual connectivity terminal device, performed by a source master node, the method including:
sending a cell mobility procedure request message to a target node in response to meeting a preset condition, wherein the request message is configured to instruct the target node to prepare a target candidate secondary cell group SCG and/or a target candidate master cell group MCG for the dual connectivity terminal device, the target node is a target master node or a target secondary node.

In a third aspect, embodiments of the present disclosure provide a method for updating a cell group of a dual connectivity terminal device, performed by a target secondary node, the method including:
receiving a cell mobility procedure request message sent by a node, wherein the request message is configured to instruct the target secondary node to prepare a target candidate secondary cell group SCG for the dual connectivity terminal device, the node is any one of the following: a source master node, a source secondary node, and a target master node.

In a fourth aspect, embodiments of the present disclosure provide a method for updating a cell group of a dual connectivity terminal device, performed by a target master node, the method including:
receiving a cell mobility procedure request message sent by a source master node, wherein the request message is configured to instruct the target master node to prepare a target candidate secondary cell group SCG and/or a target candidate master cell group MCG for the dual connectivity terminal device.

In a fifth aspect, embodiments of the present disclosure provide a method for updating a cell group of a dual connectivity terminal device, including:
a source secondary node SN sending a cell mobility procedure request message to a target SN and/or a source master node MN, wherein the request message is configured to instruct the target SN and/or the source MN to prepare a target candidate secondary cell group SCG for the dual connectivity terminal device; and
the source MN sending the cell mobility procedure request message to a target MN, wherein the request message is configured to instruct the target MN to prepare the target candidate SCG and/or a target candidate MCG.

In a sixth aspect, embodiments of the present disclosure provide a communication apparatus, wherein the apparatus is configured in a source secondary node, the apparatus including: a transceiver module, configured to send a cell mobility procedure request message to a target node, wherein the request message is configured to instruct the target node to prepare a target candidate secondary cell group SCG for the dual connectivity terminal device, the target node is a target secondary node or a source master node.

In a seventh aspect, embodiments of the present disclosure provide a communication apparatus, wherein the apparatus is configured in a source master node, the apparatus includes:
a transceiver module, configured to send a cell mobility procedure request message to a target node in response to meeting a preset condition, wherein the request message is configured to instruct the target node to prepare a target candidate secondary cell group (SCG) and/or a target candidate master cell group (MCG) for the dual connectivity terminal device, the target node is a target master node or a target secondary node.

In an eighth aspect, embodiments of the present disclosure provide a communication apparatus, wherein the apparatus is configured in a target secondary node, the apparatus includes:
a transceiver module, configured to receive a cell mobility procedure request message sent by a node, wherein the request message is configured to instruct the target secondary node to prepare a target candidate secondary cell group SCG for the dual connectivity terminal device, the node is any one of the following: a source master node, a source secondary node, and a target master node.

In a ninth aspect, embodiments of the present disclosure provide a communication apparatus, wherein the apparatus is configured in a target master node, the apparatus includes:

a transceiver module, configured to receive a cell mobility procedure request message sent by a source master node, wherein the request message is configured to instruct the target master node to prepare a target candidate secondary cell group SCG and/or a target candidate master cell group MCG for the dual connectivity terminal device.

In a tenth aspect, embodiments of the present disclosure provide a communication apparatus, including a processor, wherein the processor performs the method described in the first aspect above when invoking a computer program in a memory.

In an eleventh aspect, embodiments of the present disclosure provide a communication apparatus, including a processor, wherein the processor performs the method described in the second aspect above when invoking a computer program in a memory.

In a twelfth aspect, embodiments of the present disclosure provide a communication apparatus, including a processor, wherein the processor performs the method described in the third aspect above when invoking a computer program in a memory.

In a thirteenth aspect, embodiments of the present disclosure provide a communication apparatus, including a processor, wherein the processor performs the method described in the fourth aspect above when invoking a computer program in a memory.

In a fourteenth aspect, embodiments of the present disclosure provide a communication apparatus, including a processor and a memory in which a computer program is stored; wherein the processor executes the computer program stored in the memory to cause the communication apparatus to perform the method described in the first aspect above.

In a fifteenth aspect, embodiments of the present disclosure provide a communication apparatus, including a processor and a memory in which a computer program is stored; wherein the processor executes the computer program stored in the memory to cause the communication apparatus to perform the method described in the second aspect above.

In a sixteenth aspect, embodiments of the present disclosure provide a communication apparatus, including a processor and a memory in which a computer program is stored; wherein the processor executes the computer program stored in the memory to cause the communication apparatus to perform the method described in the third aspect above.

In a seventeenth aspect, embodiments of the present disclosure provide a communication apparatus, including a processor and a memory in which a computer program is stored; wherein the processor executes the computer program stored in the memory to cause the communication apparatus to perform the method described in the fourth aspect above.

In an eighteenth aspect, embodiments of the present disclosure provide a communication apparatus, including a processor and an interface circuit, wherein the interface circuit is used for receiving code instructions and transmitting them to the processor, the processor is used to run the code instructions to cause the apparatus to perform the method described in the first aspect above.

In a nineteenth aspect, embodiments of the present disclosure provide a communication apparatus, including a processor and an interface circuit, wherein the interface circuit is used for receiving code instructions and transmitting them to the processor, the processor is used to run the code instructions to cause the apparatus to perform the method described in the second aspect above.

In a twentieth aspect, embodiments of the present disclosure provide a communication apparatus, including a processor and an interface circuit, wherein the interface circuit is used for receiving code instructions and transmitting them to the processor, the processor is used to run the code instructions to cause the apparatus to perform the method described in the third aspect above.

In a twenty-first aspect, embodiments of the present disclosure provide a communication apparatus, including a processor and an interface circuit, wherein the interface circuit is used for receiving code instructions and transmitting them to the processor, the processor is used to run the code instructions to cause the apparatus to perform the method described in the fourth aspect above.

In a twenty-second aspect, embodiments of the present disclosure provide a communication system, including a communication apparatus described in the fifth aspect, a communication apparatus described in the sixth aspect, a communication apparatus described in the seventh aspect, and a communication apparatus described in the eighth aspect, or, alternatively, the system includes a communication apparatus described in the ninth aspect, a communication apparatus described in the tenth aspect, a communication apparatus described in the eleventh aspect, and a communication apparatus described in the twelfth aspect, or, alternatively, the system includes the communication apparatus described in the thirteenth aspect, the communication apparatus described in the fourteenth aspect, the communication apparatus described in the fifteenth aspect, and the communication apparatus described in the sixteenth aspect, or, alternatively, the system includes the communication apparatus described in the seventeenth aspect, the communication apparatus described in the eighteenth aspect, the communication apparatus described in the nineteenth aspect, and the communication apparatus described in the twentieth aspect.

In a twenty-third aspect, embodiments of the present disclosure provide a computer-readable storage medium, for storing instructions used by the terminal device, wherein the instructions cause the terminal device to perform the method described in the first aspect above when executed.

In a twenty-fourth aspect, embodiments of the present disclosure provide a readable storage medium, for storing instructions used by the network device, wherein the instructions cause the network device to perform the method described in the second aspect above when executed.

In a twenty-fifth aspect, embodiments of the present disclosure provide a readable storage medium, for storing instructions used by the network device, wherein the instructions cause the network device to perform the method described in the third aspect above when executed.

In a twenty-sixth aspect, embodiments of the present disclosure provide a readable storage medium, for storing instructions used by the network device, wherein the instructions cause the network device to perform the method described in the fourth aspect above when executed.

In a twenty-seventh aspect, the present disclosure further provides a computer program product including a computer program, which, when run on a computer, causes the computer to perform the method described in the first aspect above.

In a twenty-eighth aspect, the present disclosure further provides a computer program product including a computer program, which, when run on a computer, causes the computer to perform the method described in the second aspect above.

In a twenty-ninth aspect, the present disclosure further provides a computer program product including a computer program, which, when run on a computer, causes the computer to perform the method described in the third aspect above.

In a thirtieth aspect, the present disclosure further provides a computer program product including a computer program, which, when run on a computer, causes the computer to perform the method described in the fourth aspect above.

In a thirty-first aspect, the present disclosure provides a chip system including at least one processor and an interface for supporting a network device to achieve functions involved in the first aspect, e.g. determining or processing at least one of the data and information involved in the above methods. In one possible design, the chip system further includes a memory, the memory is used for storing the necessary computer program and data of the source secondary node. The chip system may be composed of a chip or may also include a chip and other discrete devices.

In a thirty-second aspect, the present disclosure provides a chip system including at least one processor and an interface for supporting an auxiliary communication device to achieve functions involved in the second aspect, e.g. determining or processing at least one of the data and information involved in the above methods. In one possible design, the chip system further includes a memory, the memory is used for storing the necessary computer program and data of the source master node. The chip system may be composed of a chip or may also include a chip and other discrete devices.

In a thirty-third aspect, the present disclosure provides a chip system including at least one processor and an interface for supporting a terminal device to achieve functions involved in the second aspect, e.g. determining or processing at least one of the data and information involved in the above methods. In one possible design, the chip system further includes a memory, the memory is used for storing the necessary computer program and data of the target secondary node. The chip system may be composed of a chip or may also include a chip and other discrete devices.

In a thirty-fourth aspect, the present disclosure provides a chip system including at least one processor and an interface for supporting a terminal device to achieve functions involved in the second aspect, e.g. determining or processing at least one of the data and information involved in the above methods. In one possible design, the chip system further includes a memory, the memory is used for storing the necessary computer program and data of the target master node. The chip system may be composed of a chip or may also include a chip and other discrete devices.

In a thirty-fifth aspect, the present disclosure provides a computer program which, when run on a computer, causes the computer to perform the method described in the first aspect above.

In a thirty-sixth aspect, the present disclosure provides a computer program that, when run on a computer, causes the computer to perform the method described in the second aspect above.

In a thirty-seventh aspect, the present disclosure provides a computer program that, when run on a computer, causes the computer to perform the method described in the third aspect above.

In a thirty-eighth aspect, the present disclosure provides a computer program which, when run on a computer, causes the computer to perform the method described in the fourth aspect above.

### BRIEF DESCRIPTION OF THE DRAWINGS

In order to more clearly illustrate the technical solutions in the embodiments of the present disclosure or the background art, the accompanying drawings used in the embodiments of the present disclosure or the background art will be described below.

FIG. 1 is a schematic diagram of an architecture of a communication system provided by an embodiment of the present disclosure;

FIG. 2 is a flowchart of a method for updating a cell group of a dual connectivity terminal device provided by an embodiment of the present disclosure;

FIG. 3 is a flowchart of a method for updating a cell group of a dual connectivity terminal device provided by an embodiment of the present disclosure;

FIG. 4 is a flowchart of a method for updating a cell group of a dual connectivity terminal device provided by an embodiment of the present disclosure;

FIG. 5 is a flowchart of a method for updating a cell group of a dual connectivity terminal device provided by an embodiment of the present disclosure;

FIG. 6 is a flowchart of a method for updating a cell group of a dual connectivity terminal device provided by an embodiment of the present disclosure;

FIG. 7 is a flowchart of a method for updating a cell group of a dual connectivity terminal device provided by an embodiment of the present disclosure;

FIG. 8 is a flowchart of a method for updating a cell group of a dual connectivity terminal device provided by an embodiment of the present disclosure;

FIG. 9 is a flowchart of a method for updating a cell group of a dual connectivity terminal device provided by an embodiment of the present disclosure;

FIG. 10 is a flowchart of a method for updating a cell group of a dual connectivity terminal device provided by an embodiment of the present disclosure;

FIG. 11 is a flowchart of a method for updating a cell group of a dual connectivity terminal device provided by an embodiment of the present disclosure;

FIG. 12 is a flowchart of a method for updating a cell group of a dual connectivity terminal device provided by an embodiment of the present disclosure;

FIG. 13 is a flowchart of a method for updating a cell group of a dual connectivity terminal device provided by an embodiment of the present disclosure;

FIG. 14 is an interaction schematic diagram of a method for updating a cell group of a dual connectivity terminal device provided by an embodiment of the present disclosure;

FIG. 14a is an interaction schematic diagram of a method for updating a cell group of a dual connectivity terminal device provided by an embodiment of the present disclosure;

FIG. 15 is an interaction schematic diagram of a method for updating a cell group of a dual connectivity terminal device provided by an embodiment of the present disclosure; FIG. 16 is an interaction schematic diagram of a method for updating a cell group of a dual connectivity terminal device provided by an embodiment of the present disclosure;

FIG. 17 is an interaction schematic diagram of a method for updating a cell group of a dual connectivity terminal device provided by an embodiment of the present disclosure;

FIG. 18 is a schematic diagram of a structure of a communication apparatus provided by an embodiment of the present disclosure;

FIG. 19 is another schematic diagram of a structure of a communication apparatus provided by an embodiment of the present disclosure; and

FIG. 20 is a schematic diagram of a structure of a chip provided by an embodiment of the present disclosure.

### DETAILED DESCRIPTION

For ease of understanding, the terms involved in the present disclosure are first introduced.

### 1. Primary Cell (PCell)

Under the MCG, there may be a plurality of Cells, one of which is used to initiate the initial access, and this cell is called a PCell, which, as the name suggests, is the most “primary” cell in the MCG.

### 2. Secondary Cell (SCell)

The secondary cell in the MCG is the SCell, and the PCell under MCG and SCell under MCG are combined together through carrier aggregation CA, and MCG contains one or more SCells.

### 3. Primary Secondary Cell (PSCell)

The primary secondary cell in the SCG is the PSCell, and the SCG contains one or more SCells.

### 4. Source MN

It is the MN that currently serves the terminal device.

### 5. Source SN

It is the SN that currently serves the terminal device.

### 6. Target MN

It is the MN used to “prepare target candidate SCG” and “prepare target candidate MCG” for the terminal device.

### 7. Target SN

It is the SN used to “prepare target candidate SCG” and “prepare target candidate MCG” for the terminal device.

### 8. Condition-Based Triggered Mobility Procedure

In the 5th Generation Mobile Communication Technology (5G) system, a terminal device can perform cell mobility based on a “pre-configured condition” of a network device and a “pre-configured cell” corresponding to the condition. When the terminal device satisfies the “pre-configured condition”, such as a specific measurement event, the terminal device changes the service cell to the “pre-configured cell”. The “condition-based triggered mobility procedure” includes: Conditional Handover (CHO), Conditional PSCell Addition (CPA) and Conditional PSCell Change (CPC).

### 9. Selective Activation Cell Group Procedure

In the 5G system, the network device can provide “pre-configured cell group” for the terminal device. The network device can subsequently activate or de-activate the “pre-configured cell group” through activation signaling, without having to re-supply the configuration of the group.

In order to better understand a method for updating a cell group of a dual connectivity terminal device disclosed in an embodiment of the present disclosure, a communication system applicable to an embodiment of the present disclosure is first described below.

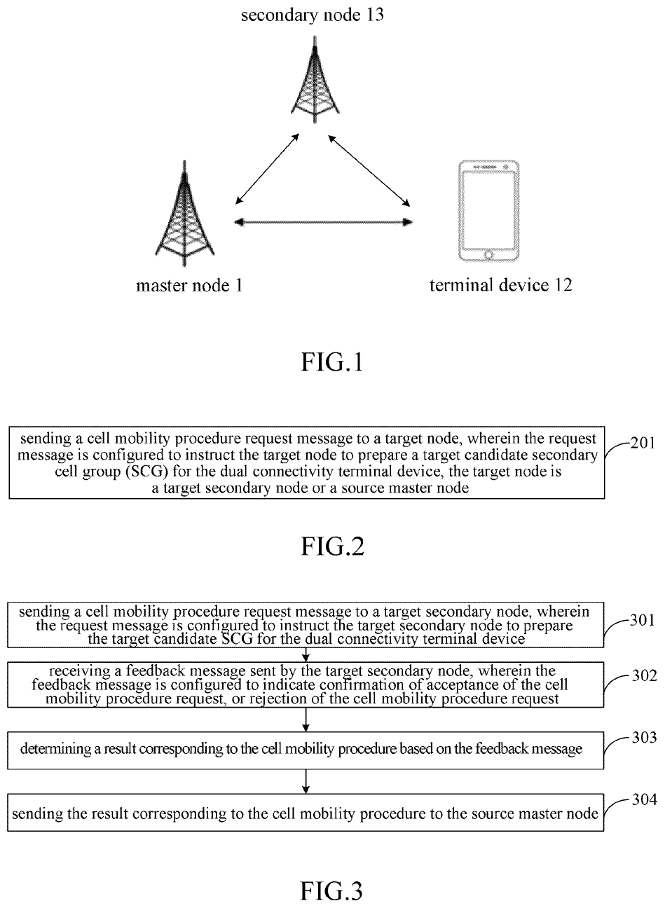

Referring to FIG. 1, FIG. 1 shows a schematic diagram of an architecture of a communication system provided by an embodiment of the present disclosure. The communication system may include, but is not limited to, a network device and a terminal device. The number and form of the devices shown in FIG. 1 are for example only and do not constitute a limitation of the embodiment of the present disclosure. In practical applications, it may include two or more network devices, two or more auxiliary communication devices, and two or more terminal devices. For example, the communication system shown in FIG. 1 includes a master node 11, a terminal device 12, and a secondary node device 13.

It should be noted that the technical solution of the embodiment of the present disclosure may be applied to various communication systems, for example, a long term evolution (LTE) system, a 5th generation (5G) mobile communication system, a 5G new radio (NR) system, or other future new mobile communication systems.

The master node 11 and the secondary node 13 in the embodiments of the present disclosure are a kind of entity for transmitting or receiving signals on the network side, which may be a master node and a secondary node corresponding to the terminal device 12, respectively. For example, the master node 11 and the secondary node 13 may be, respectively, an evolved NodeB (eNB), a transmission reception point (TRP), a next generation NodeB (gNB) in a NR system, a base station in other future mobile communication systems, or an access node in the wireless fidelity (WiFi) system, and the like. The embodiments of the present disclosure do not limit the specific technology and the specific device form adopted for the network device. The network device provided by embodiments of the present disclosure may be composed of a central unit (CU) and a distributed unit (DU). The CU may also be referred to as a control unit. The structure of the CU-DU may be used to split the protocol layers of the network device, such as the base station. The functions of a part of the protocol layers are placed in the CU for centralized control, and the functions of the remaining part or all of the protocol layers are distributed in the DU, with the CU centrally controlling the DU.

The terminal device 12 in embodiments of the present disclosure is an entity for receiving or transmitting signals on the user side, such as a mobile phone. The terminal device may also be referred to as a terminal, user equipment (UE), mobile station (MS), mobile terminal (MT), and the like. The terminal device can be cars with communication functions, intelligent cars, mobile phones, wearable devices, tablet computers (Pad), computers with wireless transceiver functions, virtual reality (VR) terminal device, augmented reality (AR) terminal device, wireless terminal device in industrial control, and wireless terminal device in self-driving, wireless terminal device in remote medical surgery, wireless terminal device in smart grid, wireless terminal device in transportation safety, wireless terminal device in smart city, wireless terminal device in smart home, and so on. The embodiments of the present disclosure do not limit the specific technologies and specific equipment forms used for the terminal devices.

It is understood that, the communication system described in the embodiments of the present disclosure is intended to more clearly illustrate the technical solutions of the embodiments of the present disclosure and does not constitute a limitation of the technical solutions provided in the embodiments of the present disclosure. The ordinary technicians in the field may know that, with the evolution of the system architecture and the emergence of new business scenarios, the technical solutions provided in the embodiments of the present disclosure are equally applicable to similar technical problems.

For the terminal device supporting DC, if it is not possible to perform “a condition-based triggered mobility procedure” or “a selective activation cell group procedure” for MCG and SCG at the same time, that is, it is not possible to change the MCG and SCG of the DC terminal device at the same time, or add the SCG while changing the MCG, the mobility gain brought about by the above two techniques can only be obtained in any one cell group of the MCG or SCG, thus affecting the mobility performance of the terminal device. In the present disclosure, by introducing a reasonable negotiation process of network nodes, a terminal supporting DC can perform “a condition-based triggered mobility procedure” or “a selective activation cell group procedure” for MCG and SCG at the same time, that is, the MCG and SCG can be changed at the same time, or the SCG is added while changing the MCG, thereby improving the mobility performance of the terminal device and improving the reliability of the terminal device during the mobility procedure.

Referring to FIG. 2, FIG. 2 is a flow diagram of a method for updating a cell group of a dual connectivity terminal device provided by an embodiment of the present disclosure, and the method is performed by a source secondary node. As shown in FIG. 2, the method may include, but is not limited to the following step:
step 201, sending a cell mobility procedure request message to a target node, wherein the request message is configured to instruct the target node to prepare a target candidate secondary cell group SCG for the dual connectivity terminal device, the target node is a target secondary node or a source master node.

Optionally, the cell mobility procedure includes at least one of the following: a condition-based triggered mobility procedure, and a selective activation cell group procedure.

In the present disclosure, after determining that the DC terminal device satisfies the condition-based triggered mobility procedure and/or the selective activation cell group procedure, the source SN sends a cell mobility procedure request message to the source MN, requests the source MN to prepare the target candidate SCG for the DC terminal device, so that the source MN can interact with the target SN and/or the target MN, thereby enabling the execution of “a condition-based triggered mobility procedure” or “a selective activation cell group procedure” for MCG and SCG of the DC terminal device at the same time.

Optionally, after determining that the DC terminal device satisfies the condition-based triggered mobility procedure and/or the selective activation cell group procedure, the source SN sends a cell mobility procedure request message to the target SN, requests the target SN to prepare a candidate SCG for the DC terminal device, and interacts with the source MN and/or the target MN, thereby enabling the execution of “a condition-based triggered mobility procedure” or “a selective activation cell group procedure” for MCG and SCG of the DC terminal device at the same time.

In the present disclosure, in the case where a DC terminal device satisfies a cell mobility procedure, a source SN sends a cell mobility procedure request message to a source MN or a target SN, through the negotiation of the network nodes, the terminal supporting DC is able to perform “a condition-based triggered mobility procedure” or “a selective activation cell group procedure” for MCG and SCG at the same time, which improves the reliability of the terminal mobility procedure.

Referring to FIG. 3, FIG. 3 is a flowchart of a method for updating a cell group of a dual connectivity terminal device provided by an embodiment of the present disclosure, which is performed by a source SN. As shown in FIG. 3, the method may include, but is not limited to, the following steps.

Step 301, a cell mobility procedure request message is sent to a target secondary node, wherein the request message is configured to instruct the target secondary node to prepare the target candidate SCG for the dual connectivity terminal device.

The specific implementation of step 301 may refer to the detail description of any of the embodiments in the present disclosure, and will not be repeated herein.

Step 302, a feedback message sent by the target secondary node is received, wherein the feedback message is configured to indicate confirmation of acceptance of the cell mobility procedure request, or rejection of the cell mobility procedure request.

Typically, the request message may include requirement information of the target candidate SCG, for example, the cell channel quality, the requested type of service, the data rate, and the current load of the target cell, so that the target SN may comprehensively determine whether the request can be subjected to access control based on the requirement information of the target candidate SCG in the request message. If the request can be accepted, it can feed back the acceptance of the cell mobility procedure request, or if it is rejected, it can feed back the rejection of the cell mobility procedure request.

Step 303, based on the feedback message, a result corresponding to the cell mobility procedure is determined.

Step 304, the result corresponding to the cell mobility procedure is sent to the source master node.

In the present disclosure, the source SN, upon receiving the feedback message from the target SN, can determine whether the target SN can prepare the target candidate SCG, and thus determine the message to be sent to the source MN based on the feedback message.

Optionally, if the target SN rejects to prepare the target candidate SCG, the source SN may send a message to the source MN indicating that the target SN rejects to prepare the target candidate SCG, thereby triggering the source MN to prepare the target candidate SCG and prepare the target candidate MCG.

Optionally, if the target SN accepts to prepare the target candidate SCG, the source SN can send a message to the source MN indicating that the target SN accepts to prepare the target candidate SCG, thereby triggering the source MN to prepare the target candidate MCG.

In the present disclosure, in the case where the DC terminal device has satisfied the cell mobility procedure, a cell mobility procedure request message is sent from the source SN to the target SN, after which, upon receiving a feedback message returned from the target SN, the result corresponding to the request message is sent to the source MN, thereby triggering the source MN to negotiate with other network nodes, so as to enable the terminal supporting DC to perform “a condition-based triggered mobility procedure” or “a selective activation cell group procedure” for MCG and SCG at the same time, which improves the reliability of the terminal mobility procedure.

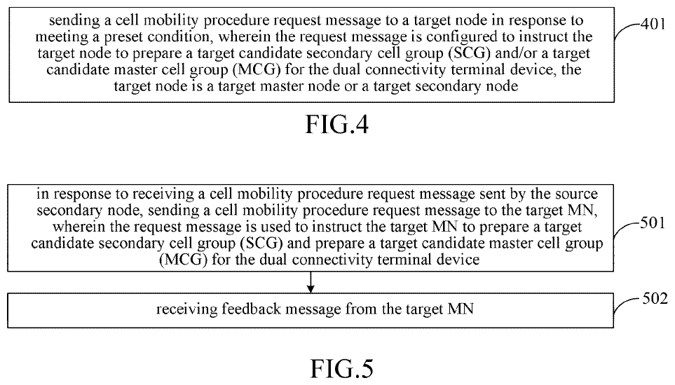

Referring to FIG. 4, FIG. 4 is a flowchart of a method for updating a cell group of a dual connectivity terminal device provided by an embodiment of the present disclosure, which is performed by a source MN. As shown in FIG. 4, the method may include, but is not limited to, the following steps.

Step 401, a cell mobility procedure request message is sent to a target node in response to meeting a preset condition, wherein the request message is configured to instruct the target node to prepare a target candidate secondary cell group SCG and/or a target candidate master cell group MCG for the dual connectivity terminal device, the target node is a target master node or a target secondary node.

Optionally, the preset condition includes any one of the following: initiating a handover procedure; initiating a SCG addition procedure; initiating a SCG change procedure; receiving a cell mobility procedure request message sent by a source secondary node; receiving a result corresponding to the cell mobility procedure sent by the source secondary node, wherein the result corresponding to the cell mobility procedure is configured to indicate a feedback message of the target SN on the cell mobility procedure.

The cell mobility procedure includes at least one of the following: a condition-based triggered mobility procedure, and a selective activation cell group procedure.

In the present disclosure, after determining that the DC terminal device satisfies the condition-based triggered mobility procedure and/or the selective activation cell group procedure, the source MN may initiate a handover procedure, or initiate a SCG addition or change procedure, and thereby request the target MN or the target SN to prepare a target candidate SCG and or a target candidate MCG for the DC terminal device.

Optionally, the source MN may also, upon receiving the cell mobility procedure request message sent by the source SN, send a cell mobility procedure request message to the target SN, requesting the target SN to prepare a target candidate SCG for the DC terminal device, thereby triggering the target SN to prepare a target candidate SCG for the DC terminal device; alternatively, requesting the target MN to prepare a target candidate MCG and a target candidate SCG for the DC terminal device, to trigger the target MN to prepare a target candidate MCG and a target candidate SCG for the DC terminal device, thereby enabling the execution of “a condition-based triggered mobility procedure” or “a selective activation cell group procedure” for MCG and SCG of the DC terminal device at the same time.

Optionally, the source MN, upon receiving a result corresponding to the cell mobility procedure sent by the source SN, may determine a result that the target SN prepares a target candidate SCG for the DC terminal device, and based on the result, send a cell mobility procedure request message to the target MN, to request the target MN to prepare a target candidate MCG and/or a target SCG for the DC terminal device, thereby enabling the execution of “a condition-based triggered mobility procedure” or “a selective activation cell group procedure” for MCG and SCG of the DC terminal device at the same time.

In the present disclosure, the source MN can send a cell mobility procedure request message to the target MN or the target SN when it is determined that the preset condition is satisfied, to trigger the target MN or the target SN to prepare a target candidate MCG and/or a target candidate SCG for the DC terminal device, thereby enabling the execution of “a condition-based triggered mobility procedure” or “a selective activation cell group procedure” for MCG and SCG of the DC terminal device at the same time.

Referring to FIG. 5, FIG. 5 is a flowchart of a method for updating a cell group of a dual connectivity terminal device provided by another embodiment of the present disclosure, which is performed by a source MN. As shown in FIG. 5, the method may include, but is not limited to, the following steps.

Step 501, in response to receiving a cell mobility procedure request message sent by the source secondary node, a cell mobility procedure request message is sent to the target MN, wherein the request message is used to instruct the target MN to prepare a target candidate secondary cell group SCG and prepare a target candidate master cell group MCG for the dual connectivity terminal device.

Optionally, the source MN, upon receiving the cell mobility procedure request message sent by the source SN, may send the cell mobility procedure request message to the target MN, to request the target MN to prepare the target candidate MCG and the target candidate SCG for the DC terminal device, to trigger the target MN to prepare the target candidate MCG and the target candidate SCG for the DC terminal device, thereby enabling the execution of “a condition-based triggered mobility procedure” or “a selective activation cell group procedure” for MCG and SCG of the DC terminal device at the same time.

Step 502, a feedback message sent by the target MN is received.

The feedback message is used to indicate any of the following: acceptance of preparing the target candidate MCG, rejection of preparing the target candidate MCG, rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target SCG but rejection of preparing the target MCG.

In the present disclosure, the target MN, after receiving the cell mobility procedure request message sent by the source MN, may determine whether or not it is possible to prepare the target candidate MCG and the target candidate SCG by the access control, and based on the result of the judgement, a feedback message is sent to the target MN.

For example, if the cell mobility procedure request message sent by the source MN requests the target MN to prepare the target candidate MCG, the target MN may determine whether or not it is possible to prepare the target candidate MCG by the access control, and based on the result of the judgement, a message is fed back to the source MN, e.g., acceptance of preparing the target candidate MCG, or rejection of preparing the target candidate MCG is fed back to the source MN.

Alternatively, if the target MN determines that it is possible to prepare the target candidate MCG and the target candidate SCG by the access control, it may provide feedback to the source MN the acceptance of preparing the target candidate MCG and the target candidate SCG; or, if it determines that it is not possible to prepare the target candidate MCG and the target candidate SCG by the access control, it may provide feedback to the source MN the rejection of preparing the target candidate MCG and the target candidate SCG.

Optionally, after receiving the cell mobility procedure request message sent by the source MN, the target MN may determine whether or not it is possible to prepare the target candidate MCG by the access control, and send the cell mobility procedure request message to the target SN, to request the target SN to prepare the target candidate SCG, and based on the feedback message of the target SN, determine the feedback message to be sent to the target MN.

For example, if the feedback information of the target SN indicates that it can prepare the target candidate SCG, and the target MN determines that it can prepare the target candidate MCG by the access control, the indication in the feedback message sent to the source MN may be: acceptance of preparing the target candidate MCG and the target candidate SCG.

Alternatively, if the feedback message of the target SN indicates that it can prepare the target candidate SCG and the target MN determines that it is unable to prepare the target candidate MCG by the access control, the indication in the feedback message sent to the source MN may be: rejection of preparing the target candidate MCG but acceptance of preparing the target candidate SCG.

Alternatively, if the feedback message of the target SN indicates that it rejects to prepare the target candidate SCG and the target MN determines that it is unable to prepare the target candidate MCG by the access control, the indication in the feedback message sent to the source MN may be: rejection of preparing the target candidate MCG and the target candidate SCG.

Alternatively, if the feedback message of the target SN indicates that it can prepare the target candidate SCG and the target MN determines that it is unable to prepare the target candidate MCG by the access control, the indication in the feedback message sent to the source MN may be: acceptance of preparing the target candidate MCG, but rejection of preparing the target candidate SCG.

In the present disclosure, after receiving the request message from the source MN, the target MN may comprehensively judge whether the request may be subjected to the access control based on the requirement information of the target candidate SCG and the target candidate MCG in the request message, such as, for example, the quality of the cell channel, the requested type of service, the data rate, and the current load of the target cell. For example, whether it is possible to prepare the target candidate MCG, whether it is possible to prepare the target candidate SCG, and send a feedback message to the source MN, thereby enabling the execution of “a condition-based triggered mobility procedure” or “a selective activation cell group procedure” for MCG and SCG of the DC terminal device at the same time.

In the present disclosure, after receiving the cell mobility procedure request message sent from the source SN, the source MN can send a cell mobility procedure request message to the target MN, to request the target MN to prepare the target candidate SCG and prepare the target candidate MCG, thereby enabling the execution of “a condition-based triggered mobility procedure” or “a selective activation cell group procedure” for MCG and SCG of the DC terminal device at the same time, through the negotiation among the source SN, the source MN and the target MN.

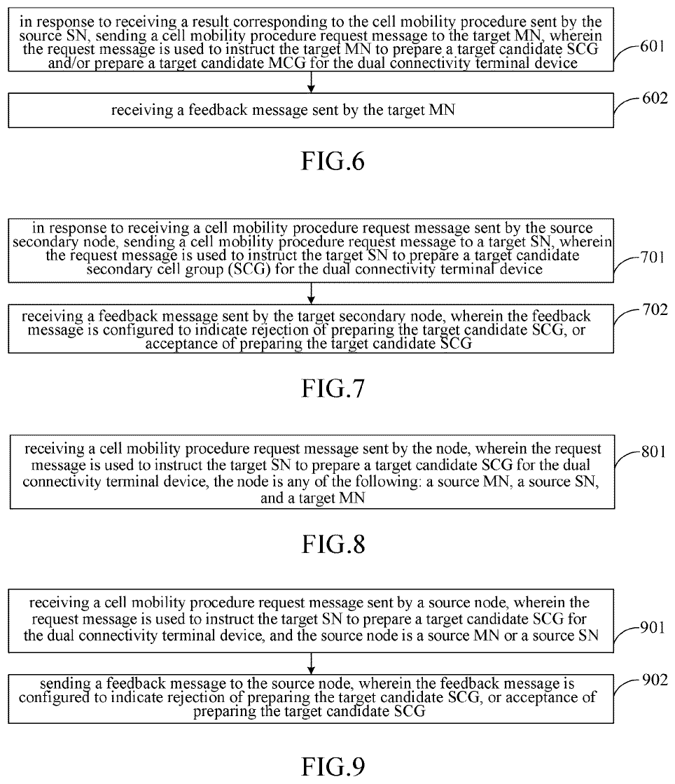

Referring to FIG. 6, FIG. 6 is a flowchart of a method for updating a cell group of a dual connectivity terminal device provided by another embodiment of the present disclosure, which is performed by a source MN. As shown in FIG. 6, the method may include, but is not limited to, the following steps.

Step 601, in response to receiving a result corresponding to the cell mobility procedure sent by the source SN, a cell mobility procedure request message is sent to the target MN, wherein the request message is used to instruct the target MN to prepare a target candidate SCG and/or prepare a target candidate MCG for the dual connectivity terminal device.

The result corresponding to the cell mobility procedure is used to characterize a feedback message of the target SN on the cell mobility procedure.

In the present disclosure, the source MN may determine whether the target SN may accept the preparation of the target candidate SCG upon receiving the result corresponding to the cell mobility procedure sent by the source SN. Optionally, if the target SN rejects the preparation of the target candidate SCG, the source MN may request the target MN to prepare the target candidate SCG and prepare the target candidate MCG.

Alternatively, if the target SN accepts to prepare the target candidate SCG, the source MN may request the target MN to prepare the target candidate MCG.

Step 602, a feedback message sent by the target MN is received.

The feedback message is used to indicate any of the following: acceptance of preparing the target candidate MCG, rejection of preparing the target candidate MCG, rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target SCG but rejection of preparing the target MCG.

In the present disclosure, the target MN may determine a corresponding feedback message based on the request of the source MN and the judgement result.

For example, if the source MN requests the target MN to prepare the target candidate MCG and the target candidate SCG, and the target MN determines that it is possible to prepare the target candidate MCG and the target candidate SCG through the access control and negotiation with the target SN, it may indicate acceptance of preparing the target candidate MCG and the target candidate SCG in a feedback message sent to the source MN.

Alternatively, if the source MN requests the target MN to prepare the target candidate MCG, and the target MN determines that the target candidate MCG can be prepared by the access control, it may indicate acceptance of preparing the target candidate MCG in the feedback message sent to the source MN.

In the present disclosure, upon receiving the result corresponding to the cell mobility procedure sent by the source SN, the source MN may send a cell mobility procedure request message to the target MN, to request the target MN to prepare the target candidate SCG and/or to prepare the target candidate MCG, whereby, through the negotiation among the source SN, the source MN, the target MN, and the target SN, it achieves the execution of “a condition-based triggered mobility procedure” or “a selective activation cell group procedure” for MCG and SCG of the DC terminal device at the same time.

Referring to FIG. 7, FIG. 7 is a flowchart of a method for updating a cell group of a dual connectivity terminal device provided by another embodiment of the present disclosure, which is performed by a source MN. As shown in FIG. 7, the method may include, but is not limited to, the following steps.

Step 701, in response to receiving a cell mobility procedure request message sent by the source secondary node, a cell mobility procedure request message is sent to a target SN, wherein the request message is used to instruct the target SN to prepare a target candidate secondary cell group SCG for the dual connectivity terminal device.

The specific implementation process of step 701 may be described in detail with reference to any embodiment of the present disclosure, and will not be repeated herein.

Step 702, a feedback message sent by the target secondary node is received, wherein the feedback message is configured to indicate rejection of preparing the target candidate SCG, or acceptance of preparing the target candidate SCG.

In the present disclosure, after receiving the cell mobility procedure request message sent by the source MN, the target SN may determine whether the target candidate SCG can be prepared by the access control, and based on the judgement result, the feedback message is sent to the target MN.

It is understood that, by sending the cell mobility procedure request message to the target SN, the source MN may trigger the target SN to send the cell mobility procedure request message again to the target MN, to request the target MN to prepare the target candidate MCG, thereby enabling the execution of “a condition-based triggered mobility procedure” or “a selective activation cell group procedure” for MCG and SCG of the DC terminal device at the same time.

In the present disclosure, upon receiving a cell mobility procedure request message sent by the source SN, the source MN may send a cell mobility procedure request message to the target SN, to request the target SN to prepare the target candidate SCG. Thereby, through the negotiation among the source SN, the source MN and the target SN, it achieves the execution of “a condition-based triggered mobility procedure” or “a selective activation cell group procedure” for MCG and SCG of the DC terminal device at the same time.

Referring to FIG. 8, FIG. 8 is a flowchart of a method for updating a cell group of a dual connectivity terminal device provided by another embodiment of the present disclosure, which is performed by a target SN. As shown in FIG. 8, the method may include, but is not limited to, the following steps.

Step 801, a cell mobility procedure request message sent by the node is received, wherein the request message is used to instruct the target SN to prepare a target candidate SCG for the dual connectivity terminal device, the node is any of the following: a source MN, a source SN, and a target MN.

The cell mobility procedure includes at least one of the following: a condition-based triggered mobility procedure, and a selective activation cell group procedure.

In the present disclosure, after the target SN receives a cell mobility procedure request message sent by the node, based on the requirement information of the target candidate SCG included in the request message, such as, for example, the cell channel quality, the requested type of service, the data rate, and the current load of the target cell, etc., the target SN may, based on the requirement information of the target candidate SCG in the request message, comprehensively judge whether the request may be subjected to the access control, to determine whether the target candidate SCG can be prepared.

In the present disclosure, the target SN may receive a cell mobility procedure request message sent by the node, and based on the request message, prepare the target candidate SCG, thereby, through interaction with the node, achieving the execution of “a condition-based triggered mobility procedure” or “a selective activation cell group procedure” for MCG and SCG at the same time, which improves the reliability of the mobility procedure of the terminal.

Referring to FIG. 9, FIG. 9 is a flowchart of a method for updating a cell group of a dual connectivity terminal device provided by another embodiment of the present disclosure, which is performed by a target SN. As shown in FIG. 9, the method may include, but is not limited to, the following steps.

Step 901, a cell mobility procedure request message sent by a source node is received, wherein the request message is used to instruct the target SN to prepare a target candidate SCG for the dual connectivity terminal device, and the source node is a source MN or a source SN.

The specific implementation process of the above step 901 may be described in detail with reference to any embodiment of the present disclosure and will not be repeated herein.

Step 902, a feedback message is sent to the source node, wherein the feedback message is configured to indicate rejection of preparing the target candidate SCG, or acceptance of preparing the target candidate SCG.

In the present disclosure, after the target SN receives a cell mobility procedure request message sent by the source MN, based on the requirement information of the target candidate SCG included in the request message, such as, for example, the cell channel quality, the requested type of service, the data rate, and the current load of the target cell, etc., the target SN may, based on the requirement information of the target candidate SCG in the request message, comprehensively judge whether the request may be subjected to the access control, to determine whether the target candidate SCG can be prepared, and send a feedback message to the source node based on the judgement result.

In the present disclosure, the target SN may receive a cell mobility procedure request message sent by the source MN or the source SN, and thereafter, based on the request message, judge whether the target candidate SCG can be prepared and send a feedback message to the source node, thereby achieving, through interaction with the source node, the execution of “a condition-based triggered mobility procedure” or “a selective activation cell group procedure” for MCG and SCG at the same time, which improves the reliability of the mobility procedure of the terminal.

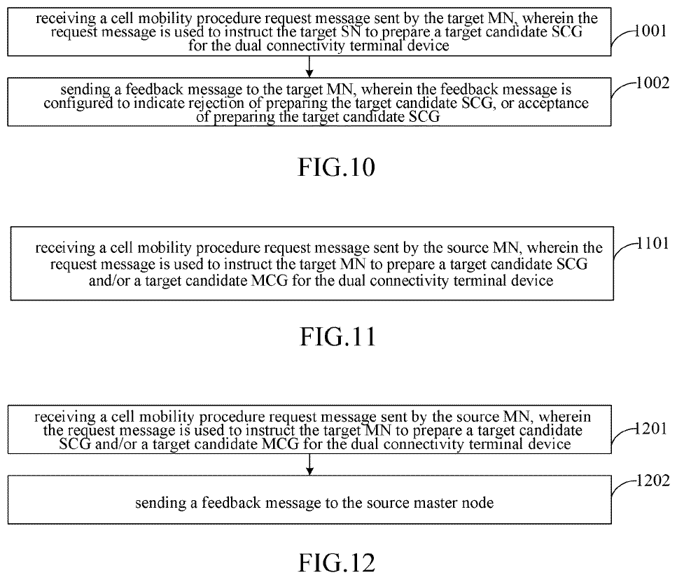

Referring to FIG. 10, FIG. 10 is a flowchart of a method for updating a cell group of a dual connectivity terminal device provided by another embodiment of the present disclosure, which is performed by a target SN. As shown in FIG. 10, the method may include, but is not limited to, the following steps.

Step 1001, a cell mobility procedure request message sent by the target MN is received, wherein the request message is used to instruct the target SN to prepare a target candidate SCG for the dual connectivity terminal device.

In the present disclosure, the source MN may send a cell mobility procedure request message to the target MN, to trigger the target MN to send a cell mobility procedure request message to the target SN, to request the target SN to prepare the target candidate SCG.

Step 1002, a feedback message is sent to the target MN, wherein the feedback message is configured to indicate rejection of preparing the target candidate SCG, or acceptance of preparing the target candidate SCG.

In the present disclosure, after receiving a cell mobility procedure request message sent by the target MN, the target SN may judge whether the target candidate SCG may be prepared by the access control based on the requirement information of the target candidate SCG included in the request message, and based on the result of the judgement, a feedback message is sent to the source node.

In the present disclosure, the target SN may receive a cell mobility procedure request message sent by the target MN, and thereafter, based on the request message, judge whether the target candidate SCG may be prepared and send a feedback message to the target MN, thereby, through interaction with the source node and the target MN, achieving the execution of “a condition-based triggered mobility procedure” or “a selective activation cell group procedure” for MCG and SCG at the same time, which improves the reliability of the mobility procedure of the terminal.

Referring to FIG. 11, FIG. 11 is a flowchart of a method for updating a cell group of a dual connectivity terminal device provided by another embodiment of the present disclosure, which is performed by a target MN. As shown in FIG. 11, the method may include, but is not limited to, the following steps.

Step 1101, a cell mobility procedure request message sent by the source MN is received, wherein the request message is used to instruct the target MN to prepare a target candidate SCG and/or a target candidate MCG for the dual connectivity terminal device.

Optionally, the cell mobility procedure includes at least one of the following: a condition-based triggered mobility procedure, and a selective activation cell group procedure.

In the present disclosure, the target MN may receive a cell mobility procedure request message sent by the source MN, thereafter, it may determine whether the target candidate SCG and/or the target candidate MCG may be prepared based on the requirement information of the target candidate SCG and/or the target candidate MCG included in the request message by determining whether the request may be subjected to the access control.

Alternatively, the target MN may receive a cell mobility procedure request message sent by the source MN, after which, based on the requirement information of the target candidate SCG and/or the target candidate MCG included in the request message, it may determine whether the target candidate SCG and the target candidate MCG may be prepared by the access control and negotiating with the target SN.

In the present disclosure, the target MN may receive the cell mobility procedure request message sent by the source MN, and then prepare the target candidate SCG and the target candidate MCG by the access control or negotiating with the target SN, thereby, through interaction with other nodes, achieving the execution of “a condition-based triggered mobility procedure” or “a selective activation cell group procedure” for MCG and SCG at the same time, which improves the reliability of the mobility procedure of the terminal.

Referring to FIG. 12, FIG. 12 is a flowchart of a method for updating a cell group of a dual connectivity terminal device provided by another embodiment of the present disclosure, which is performed by a target MN. As shown in FIG. 12, the method may include, but is not limited to, the following steps.

Step 1201, a cell mobility procedure request message sent by the source MN is received, wherein the request message is used to instruct the target MN to prepare a target candidate SCG and/or a target candidate MCG for the dual connectivity terminal device.

The specific implementation of step 1201 may be described in detail with reference to any embodiment of the present disclosure and will not be repeated herein.

Step 1202, a feedback message is sent to the source master node.

The feedback message is configured to indicate any of the following: acceptance of preparing the target candidate MCG, rejection of preparing the target candidate MCG, rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target SCG but rejection of preparing the target MCG.

Optionally, the feedback message corresponds to the cell mobility procedure request message. For example, the request message is used to instruct the target MN to prepare the target candidate MCG, the feedback message may indicate any one of the following: acceptance of preparing the target candidate MCG, rejection of preparing the target candidate MCG.

Alternatively, the request message is used to instruct the target MN to prepare the target candidate SCG and the target candidate MCG. Then the target MN may determine whether or not it is possible to accept the cell mobility procedure request by the access control, or, the target MN may determine whether or not it is possible to accept the cell mobility procedure request by the access control and negotiating with the target SN.

For example, the target MN determines, through the access control, that the cell mobility procedure request can be accepted, then the feedback message is used to indicate acceptance of the preparation of the target candidate MCG and the target candidate SCG; or, the MN determines, through the access control, that the cell mobility procedure request cannot be accepted, then the feedback message is used to indicate rejection of the preparation of the target candidate MCG and the target candidate SCG. Alternatively, the target MN determines that the target candidate MCG can be accepted but the target candidate SCG cannot be accepted through the access control, then the feedback message may indicate the rejection of preparation of the target candidate MCG and the target candidate SCG, and so on, without limitation of the present disclosure.

Alternatively, the target MN may determine whether the cell mobility procedure request can be accepted by the access control and negotiating with the target SN, and based on the determination, a feedback message is sent to the source MN.

In the present disclosure, the target MN may receive the cell mobility procedure request message sent by the source MN, and thereafter determine the feedback message by the access control or negotiating with the target SN, and send the feedback message to the source MN, thereby, through interaction with other nodes, achieving the execution of “a condition-based triggered mobility procedure” or “a selective activation cell group procedure” for MCG and SCG at the same time, which improves the reliability of the mobility procedure of the terminal.

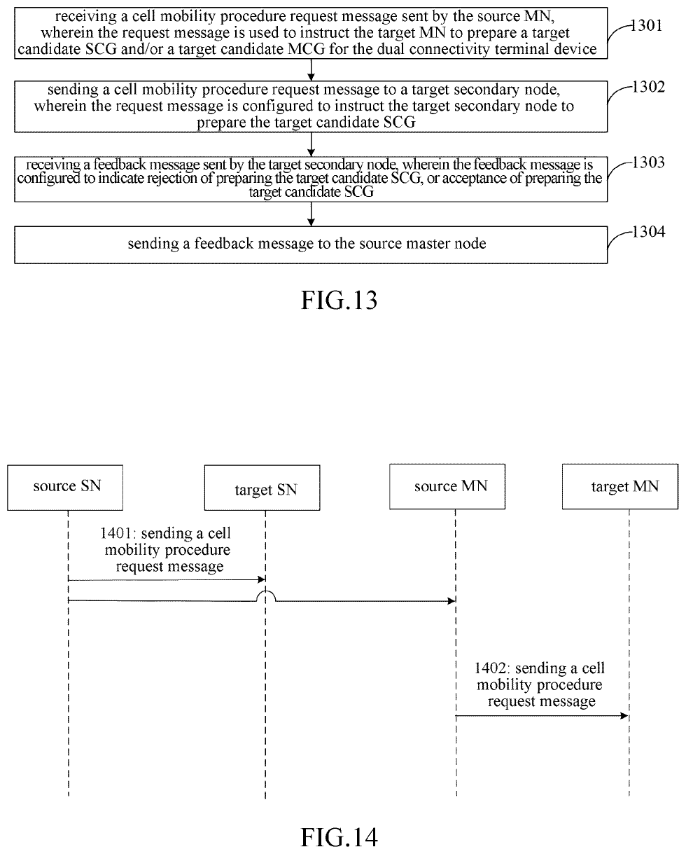

Referring to FIG. 13, FIG. 13 is a flowchart of a method for updating a cell group of a dual connectivity terminal device provided by another embodiment of the present disclosure, which is performed by a target MN. As shown in FIG. 13, the method may include, but is not limited to, the following steps.

Step 1301, a cell mobility procedure request message sent by the source MN is received, wherein the request message is used to instruct the target MN to prepare a target candidate SCG and/or a target candidate MCG for the dual connectivity terminal device.

The specific implementation of step 1301 may be described in detail with reference to any embodiment of the present disclosure and will not be repeated herein.

Step 1302, a cell mobility procedure request message is sent to a target secondary node, wherein the request message is configured to instruct the target secondary node to prepare the target candidate SCG.

Step 1303, a feedback message sent by the target secondary node is received, wherein the feedback message is configured to indicate rejection of preparing the target candidate SCG, or acceptance of preparing the target candidate SCG.

In the present disclosure, the target MN, upon receiving the cell mobility procedure request message sent by the source MN, can determine whether it can accept the preparation of the target candidate MCG by the access control. At the same time, a mobility process request message can also be sent to the target SN, to request the target SN to prepare the target candidate SCG, and receive the feedback message sent by the target SN.

Step 1304, a feedback message is sent to the source master node.

The feedback message is used to indicate any of the following: rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target SCG but rejection of preparing the target MCG.

In the present disclosure, after receiving the feedback message sent by the target SN, the target MN may determine the feedback message to be sent to the source MN based on the feedback message and its own access control result.

For example, the feedback message sent by the target SN indicates rejection of the preparation of the target candidate SCG, but the target MN determines to accept the preparation of the target candidate MCG through the access control, thus, an indication of the acceptance of the preparation of the target candidate MCG but the rejection of the preparation of the target candidate SCG may be sent to the source MN.

Alternatively, a feedback message sent by the target SN indicates the rejection of the preparation of the target candidate SCG, and the target MN determines to reject the preparation of the target candidate MCG by the access control, thus, an indication of the rejection of the preparation of the target candidate MCG and the target candidate SCG can be sent to the source MN.

Alternatively, a feedback message sent by the target SN indicates acceptance of the preparation of the target candidate SCG, and the target MN determines to reject the preparation of the target candidate MCG by the access control, thus, an indication of the rejection of the preparation of the target candidate SCG but acceptance of the target candidate MCG can be sent to the source MN.

Alternatively, a feedback message sent by the target SN indicates acceptance of the preparation of the target candidate SCG, and the target MN determines acceptance of the preparation of the target candidate MCG by the access control, thus, an indication of the acceptance of the preparation of the target candidate SCG and the target candidate MCG can be sent to the source MN.

In the present disclosure, the target MN may receive a cell mobility procedure request message sent by the source MN, and then determine a feedback message through the access control and the negotiation with the target SN, and send the feedback message to the source MN, thereby, through interaction with other nodes, achieving the execution of “a condition-based triggered mobility procedure” or “a selective activation cell group procedure” for MCG and SCG at the same time, which improves the reliability of the mobility procedure of the terminal.

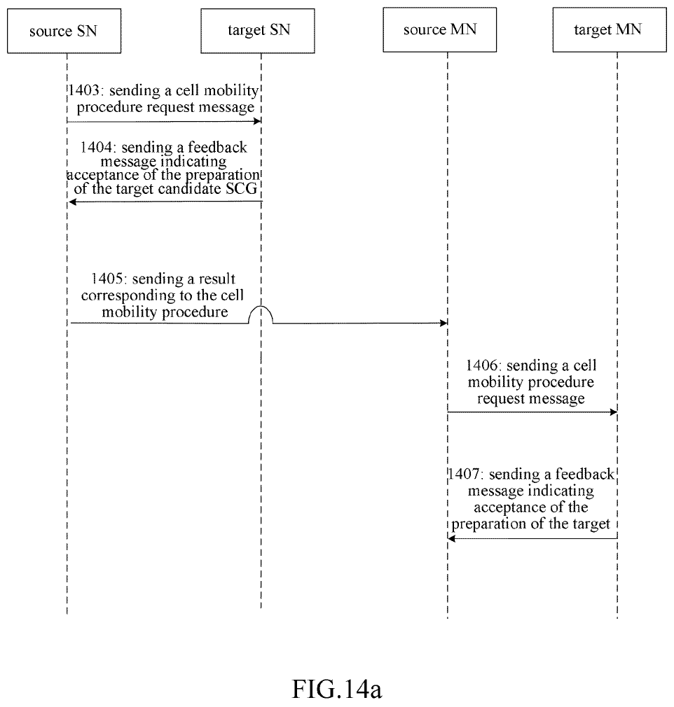

Referring to FIG. 14, FIG. 14 is an interaction schematic diagram of a method for updating a cell group of a dual connectivity terminal device provided by an embodiment of the present disclosure. As shown in FIG. 14, the method may include, but is not limited to, the following steps:
step 1401, a source secondary node SN sending a cell mobility procedure request message to a target SN and/or a source master node MN, wherein the request message is configured to instruct the target SN and/or the source MN to prepare a target candidate secondary cell group SCG for the dual connectivity terminal device; and
step 1402, the source MN sending the cell mobility procedure request message to a target MN, wherein the request message is configured to instruct the target MN to prepare the target candidate SCG and/or a target candidate MCG.

It is noted that, in the present disclosure, the source SN may send the cell mobility procedure request message to the target SN and the source MN at the same time, alternatively, it may first send the cell mobility procedure request message to the target SN, and then send the cell mobility procedure request message to the source MN based on the feedback result after receiving a feedback message sent by the target SN, alternatively, it may only send the cell mobility procedure request message to the source MN, to trigger the source MN to send the cell mobility procedure request message to the target MN, to prepare the target candidate SCG and/or the target candidate MCG for the terminal device, and the present disclosure is not limited thereto.

Optionally, the target MN may further send a feedback message to the source MN to indicate any of the following: acceptance of preparing the target candidate MCG, rejection of preparing the target candidate MCG, rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target SCG but rejection of preparing the target MCG.

Optionally, the target MN may further send a cell mobility procedure request message to the target SN, wherein the request message is configured to instruct the target SN to prepare the target candidate secondary cell group SCG; after which the target SN may perform the access control, and thereby send a feedback message to the target MN based on the result of the access control. The feedback message is used to indicate any of the following: acceptance of preparing the target candidate MCG, rejection of preparing the target candidate SCG.

In the present disclosure, through negotiation among the nodes, it achieves the execution of “a condition-based triggered mobility procedure” or “a selective activation cell group procedure” for MCG and SCG at the same time, which improves the reliability of the mobility procedure of the terminal.

Referring to FIG. 14a, FIG. 14a is an interaction schematic diagram of a method for updating a cell group of a dual connectivity terminal device provided by an embodiment of the present disclosure. As shown in FIG. 14a, the method may include, but is not limited to, the following steps.

Step 1403, the source SN sends a cell mobility procedure request message to the target SN, wherein the request message is used to instruct the target SN to prepare a target candidate SCG for the DC terminal device.

Step 1404, the source SN receives a feedback message sent by the target SN indicating acceptance of the preparation of the target candidate SCG.

The feedback message may also be a message indicating rejection of the preparation of the target candidate SCG.

Step 1405, the source SN sends a result corresponding to the cell mobility procedure to the source MN.

The result corresponding to the cell mobility procedure is used to characterize the feedback message of the target SN for the cell mobility procedure.

Step 1406, the source MN sends a cell mobility procedure request message to the target MN, wherein the request message is used to instruct the target MN to prepare a target candidate MCG for the DC terminal device.

It is noted that, the cell mobility procedure request message sent by the source MN to the target MN may also request the target MN to prepare the target candidate MCG and the target candidate SCG for the terminal device, which is not limited by the present disclosure.

Step 1407, the source MN receives a feedback message sent by the target MN indicating acceptance of the preparation of the target candidate MCG.

The implementation process of each of the above steps may be described in detail with reference to any embodiment of the present disclosure, and will not be repeated herein.

It is to be noted that, in the present embodiment, the source SN may send the cell mobility procedure request message to the target SN and the source MN at the same time, alternatively, it may first send the cell mobility procedure request message to the target SN, and then send the cell mobility procedure request message to the source MN based on the feedback result after receiving a feedback message sent by the target SN. The present disclosure does not limit this.

In the present disclosure, through negotiation among the nodes, it achieves the execution of “a condition-based triggered mobility procedure” or “a selective activation cell group procedure” for MCG and SCG at the same time, which improves the reliability of the mobility procedure of the terminal.

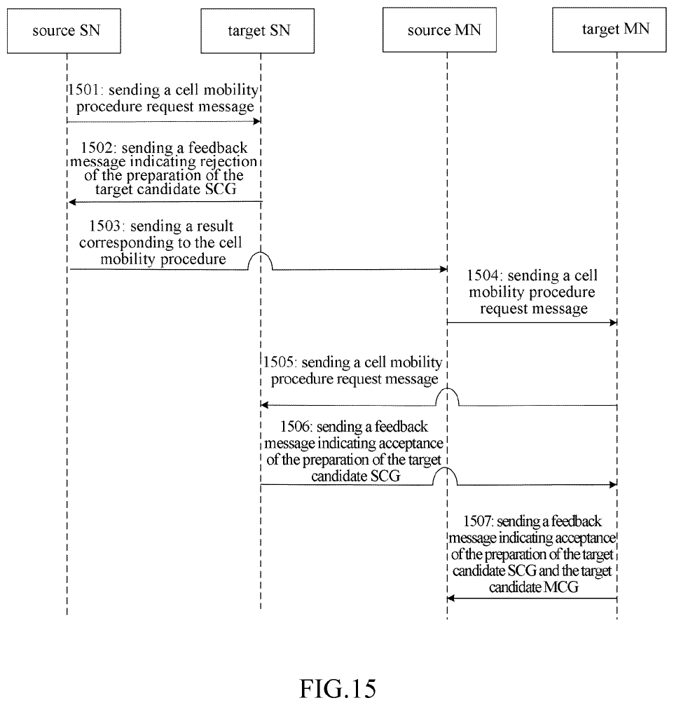

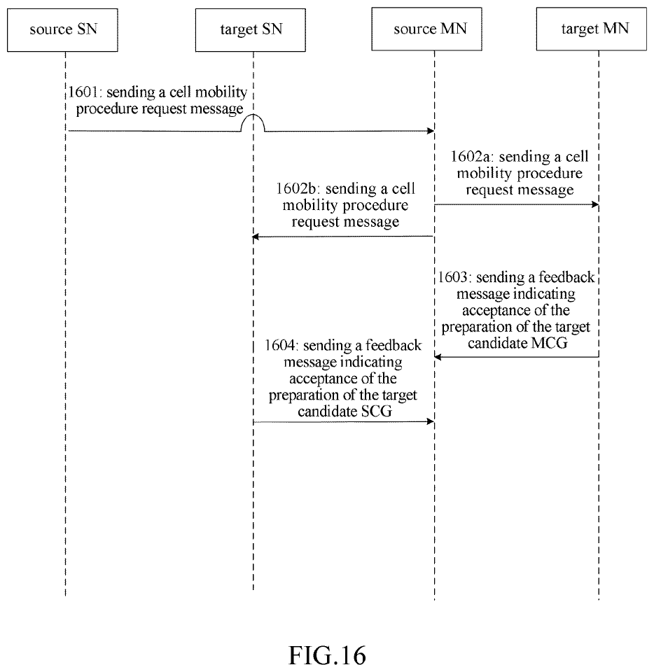

Referring to FIG. 15, FIG. 15 is an interaction schematic diagram of a method for updating a cell group of a dual connectivity terminal device provided by another embodiment of the present disclosure. As shown in FIG. 15, the method may include, but is not limited to, the following steps.

Step 1501, the source SN sends a cell mobility procedure request message to the target SN, wherein the request message is used to instruct the target SN to prepare a target candidate SCG for the DC terminal device.

Step 1502, the source SN accepts a feedback message sent by the target SN indicating rejection of the preparation of the target candidate SCG.

Step 1503, the source SN sends a result corresponding to the cell mobility procedure to the source MN.

Step 1504, the source MN sends a cell mobility procedure request message to the target MN, wherein the request message is used to instruct the target MN to prepare the target candidate MCG and the target candidate SCG for the DC terminal device.

Step 1505, the target MN sends a cell mobility procedure request message to the target SN, wherein the request message is used to instruct the target SN to prepare the target candidate SCG for the DC terminal device.

Step 1506, the target SN sends to the target MN a feedback message indicating acceptance of the preparation of the target candidate SCG.

Step 1507, the target MN sends to the source MN a feedback message indicating acceptance of the preparation of the target candidate SCG and the target candidate MCG.

In the present disclosure, through negotiation among the nodes, it achieves the execution of “a condition-based triggered mobility procedure” or “a selective activation cell group procedure” for MCG and SCG at the same time, which improves the reliability of the mobility procedure of the terminal.

Referring to FIG. 16, FIG. 16 is an interaction schematic diagram of a method for updating a cell group of a dual connectivity terminal device provided by another embodiment of the present disclosure. As shown in FIG. 16, the method may include, but is not limited to, the following steps.

Step 1601, the source SN sends a cell mobility procedure request message to the source MN, wherein the request message is used to indicate preparing a target candidate SCG for the DC terminal device.

Step 1602a, the source MN sends a cell mobility procedure request message to the target MN, wherein the request message is used to instruct the target MN to prepare a target candidate MCG for the DC terminal device.

Step 1602b, the source MN sends a cell mobility procedure request message to the target SN, wherein the request message is used to instruct the target SN to prepare a target candidate SCG for the DC terminal device.

Step 1603, the source MN accepts a feedback message sent by the target MN indicating acceptance of the preparation of the target candidate MCG.

Step 1604, the source MN accepts the feedback message sent by the target SN indicating acceptance of the preparation of the target candidate SCG.

In the present disclosure, through negotiation among the nodes, it achieves the execution of “a condition-based triggered mobility procedure” or “a selective activation cell group procedure” for MCG and SCG at the same time, which improves the reliability of the mobility procedure of the terminal.

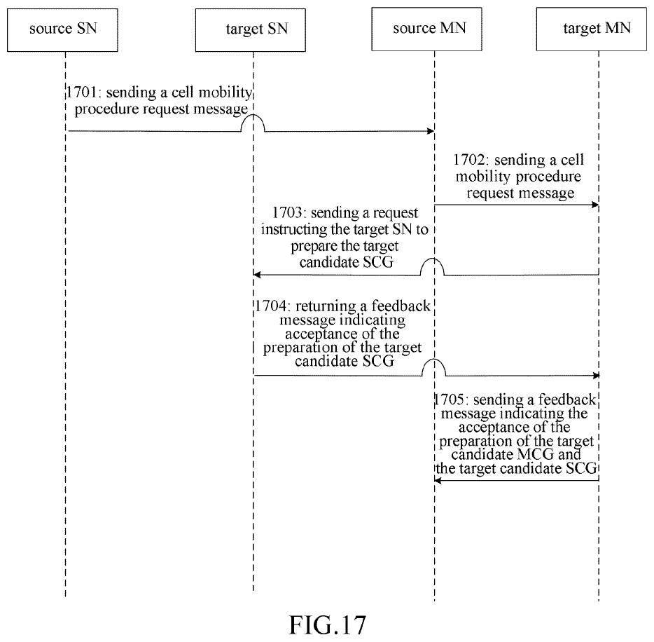

Referring to FIG. 17, FIG. 17 is an interaction schematic diagram of a method for updating a cell group of a dual connectivity terminal device provided by another embodiment of the present disclosure. As shown in FIG. 17, the method may include, but is not limited to, the following steps.

Step 1701, the source SN sends a cell mobility procedure request message to the source MN, wherein the request message is used to indicate preparing a target candidate SCG for the DC terminal device.

Step 1702, the source MN sends a cell mobility procedure request message to the target MN, wherein the request message is used to instruct the target MN to prepare a target candidate MCG and a target candidate SCG for the DC terminal device.

Step 1703, the target MN sends to the target SN a request instructing the target SN to prepare the target candidate SCG.

Step 1704, the target MN receives a feedback message returned from the target SN indicating acceptance of the preparation of the target candidate SCG.

Step 1705, the target MN sends a feedback message to the source MN indicating the acceptance of the preparation of the target candidate MCG and the target candidate SCG.

In the present disclosure, through negotiation among the nodes, it achieves the execution of “a condition-based triggered mobility procedure” or “a selective activation cell group procedure” for MCG and SCG at the same time, which improves the reliability of the mobility procedure of the terminal.

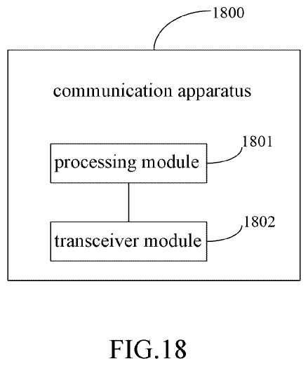

Referring to FIG. 18, a schematic diagram of a structure of a communication apparatus 1800 provided by an embodiment of the present disclosure is shown. The communication apparatus 1800 shown in FIG. 18 may include a processing module 1801 and a transceiver module 1802. The transceiver module 1802 may include a transmitter module and/or a receiver module, the transmitter module is used for realizing a transmitting function, the receiver module for realizing a receiving function, and the transceiver module 1802 may realize a transmitting function and/or a receiving function.

It will be appreciated that the communication apparatus 1800 may be a source secondary node, an apparatus in the source secondary node, or an apparatus capable of being matched for use with the source secondary node.

The communication apparatus 1800 is on the side of the source secondary node, wherein:
the transceiver module 1802 is used to send a cell mobility procedure request message to a target node, wherein the request message is configured to instruct the target node to prepare a target candidate secondary cell group SCG for the dual connectivity terminal device, the target node is a target secondary node or a source master node.

Optionally, the cell mobility procedure includes at least one of the following:
a condition-based triggered mobility procedure, and a selective activation cell group procedure. Optionally, the transceiver module 1802 is further configured to:
receive a feedback message sent by the target secondary node, wherein the feedback message is configured to indicate confirmation of acceptance of the cell mobility procedure request, or rejection of the cell mobility procedure request.

Optionally, the apparatus further includes:
a processing module 1801, configured to determine a result corresponding to the cell mobility procedure based on the feedback message;
wherein the transceiver module 1802 is configured to send the result corresponding to the cell mobility procedure to a source master node.

In the present disclosure, in the case where a DC terminal device satisfies a cell mobility procedure, a source SN sends a cell mobility procedure request message to a source MN or a target SN, through the negotiation of the network nodes, the terminal supporting DC is able to perform “a condition-based triggered mobility procedure” or “a selective activation cell group procedure” for MCG and SCG at the same time, which improves the reliability of the terminal mobility procedure.

It is understood that the communication apparatus 1800 may be a source master node, an apparatus in the source master node, or an apparatus that is capable of being matched for use with the source master node.

The communication apparatus 1800 is on the source master node side, wherein: the transceiver module 1802 is used to send a cell mobility procedure request message to a target node in response to meeting a preset condition, wherein the request message is configured to instruct the target node to prepare a target candidate secondary cell group SCG and/or a target candidate master cell group MCG for the dual connectivity terminal device, the target node is a target master node or a target secondary node.

Optionally, the preset condition includes any one of the following:
initiating a handover procedure;
initiating a SCG addition procedure;
initiating a SCG change procedure;
receiving a cell mobility procedure request message sent by a source secondary node;
receiving a result corresponding to the cell mobility procedure sent by the source secondary node, wherein the result corresponding to the cell mobility procedure is configured to indicate a feedback message of the target SN on the cell mobility procedure.

Optionally, the transceiver module 1802 is further configured to:
receive a feedback message sent by the target master node, wherein the feedback message is configured to indicate any of the following: acceptance of preparing the target candidate MCG, rejection of preparing the target candidate MCG, rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target SCG but rejection of preparing the target MCG.

Optionally, the transceiver module 1802 is further configured to:
receive a feedback message sent by the target secondary node, wherein the feedback message is configured to indicate rejection of preparing the target candidate SCG, or acceptance of preparing the target candidate SCG.

Optionally, the cell mobility procedure includes at least one of the following: a condition-based triggered mobility procedure, and a selective activation cell group procedure.

In the present disclosure, the source MN can send a cell mobility procedure request message to the target MN or the target SN when it is determined that the preset condition is satisfied, to trigger the target MN or the target SN to prepare a target candidate MCG and/or a target candidate SCG for the DC terminal device, thereby enabling the execution of “a condition-based triggered mobility procedure” or “a selective activation cell group procedure” for MCG and SCG of the DC terminal device at the same time.

It is understood that the communication apparatus 1800 may be a target secondary node, an apparatus in the target secondary node, or an apparatus that is capable of being matched for use with the target secondary node.

The communication apparatus 1800 is on the side of the target secondary node, wherein:
the transceiver module 1802 is used to receive a cell mobility procedure request message sent by a node, wherein the request message is configured to instruct the target secondary node to prepare a target candidate secondary cell group SCG for the dual connectivity terminal device, the node is any one of the following: a source master node, a source secondary node, and a target master node.

Optionally, the transceiver module 1802, is further configured to: send a feedback message to the node, wherein the feedback message is configured to indicate rejection of preparing the target candidate SCG, or acceptance of preparing the target candidate SCG.

Optionally, the cell mobility procedure includes at least one of the following: a condition-based triggered mobility procedure, and a selective activation cell group procedure.

In the present disclosure, after the target SN receives a cell mobility procedure request message sent by the source MN, based on the requirement information of the target candidate SCG included in the request message, such as, for example, the cell channel quality, the requested type of service, the data rate, and the current load of the target cell, etc., the target SN may, based on the requirement information of the target candidate SCG in the request message, comprehensively judge whether the request may be subjected to the access control, to determine whether the target candidate SCG can be prepared.

It will be appreciated that the communication apparatus 1800 may be a target master node, an apparatus in the target master node, or an apparatus that is capable of being matched for use with the target master node.

The communication apparatus 1800 is on the side of the target master node, wherein: in an eighth aspect, embodiments of the present disclosure provide a communication apparatus, wherein the apparatus is configured in a target master node, the apparatus includes:
a transceiver module 1802, configured to receive a cell mobility procedure request message sent by a source master node, wherein the request message is configured to instruct the target master node to prepare a target candidate secondary cell group SCG and/or a target candidate master cell group MCG for the dual connectivity terminal device.

Optionally, the transceiver module 1802 is further configured to:
send a cell mobility procedure request message to a target secondary node, wherein the request message is configured to instruct the target secondary node to prepare the target candidate SCG.

Optionally, the transceiver module 1802 is further configured to:
receive a feedback message sent by the target secondary node, wherein the feedback message is configured to indicate rejection of preparing the target candidate SCG, or acceptance of preparing the target candidate SCG.

Optionally, the transceiver module 1802 is further configured to:
send a feedback message to the source master node, wherein the feedback message is configured to indicate any of the following:
acceptance of preparing the target candidate MCG, rejection of preparing the target candidate MCG, rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target SCG but rejection of preparing the target MCG.

Optionally, the cell mobility procedure includes at least one of the following: a condition-based triggered mobility procedure, and a selective activation cell group procedure.

In the present disclosure, the target MN may receive a cell mobility procedure request message sent by the source MN, and then prepare the target candidate SCG and the target candidate MCG through the access control or the negotiation with the target SN, thereby, through interaction with other nodes, achieving the execution of “a condition-based triggered mobility procedure” or “a selective activation cell group procedure” for MCG and SCG at the same time, which improves the reliability of the mobility procedure of the terminal.

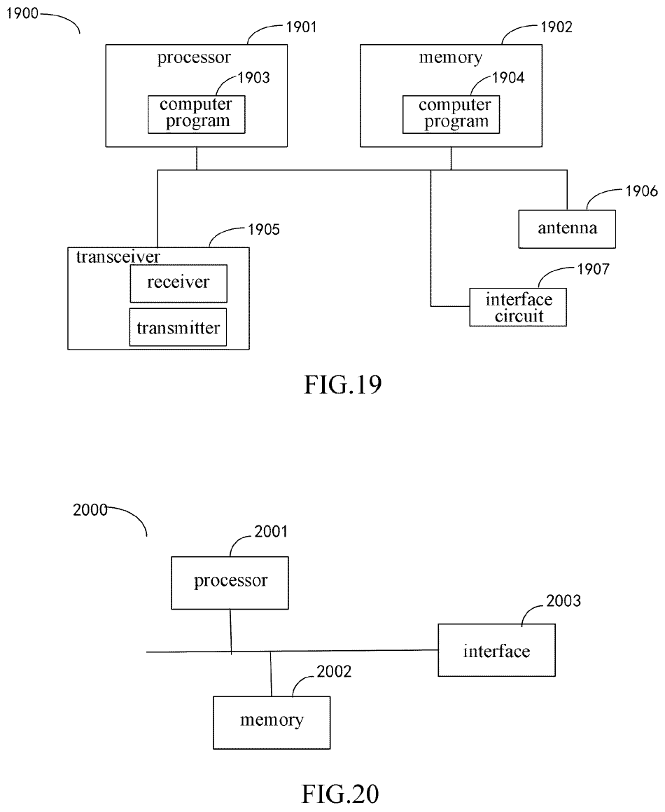

Referring to FIG. 19, FIG. 19 is another schematic diagram of a structure of a communication apparatus 1900 provided by an embodiment of the present disclosure. The communication apparatus 1900 may be a network device, or an auxiliary communication device, or a terminal device, or a chip, a chip system, or a processor, etc. that supports the network device to implement the above-described methods, or a chip, a chip system, or a processor, etc. that supports the auxiliary communication device to implement the above-described methods, or a chip, a chip system, or a processor, etc. that supports the terminal device to implement the above-described methods. The apparatus may be used to implement the methods described in the above method embodiments, which may refer to the description in the above method embodiments.

The communication apparatus 1900 may include one or more processors 1901. The processors 1901 may be general purpose processors or specialized processors, etc. For example, it may be a baseband processor or a central processor. The baseband processor may be used for processing communication protocols as well as communication data, and the central processor may be used for controlling a communication apparatus (e.g., base station, baseband chip, terminal device, terminal device chip, DU or CU, etc.), executing a computer program, and processing data of the computer program.

Optionally, one or more memories 1902 may also be included in the communication apparatus 1900, on which a computer program 1904 may be stored. The processor 1901 executes the computer program 1904 to cause the communication apparatus 1900 to carry out the methods described in the above method embodiments. Optionally, data may also be stored in the memory 1902. The communication apparatus 1900 and the memory 1902 may be provided separately or may be integrated together.

Optionally, the communication apparatus 1900 may further include a transceiver 1905, an antenna 1906. The transceiver 1905 may be referred to as a transceiver unit, a transceiver, or a transceiver circuit, etc., for achieving the transceiver functions. The transceiver 1905 may include a receiver and a transmitter, the receiver may be referred to as a receiver machine or a receiving circuit, etc., for implementing the receiving function, and the transmitter may be referred to as a transmitter machine or a transmitting circuit, etc., for implementing the transmitting function.

Optionally, one or more interface circuits 1907 may also be included in the communication apparatus 1900. The interface circuits 1907 are used to receive code instructions and transmit them to the processor 1901. The processor 1901 runs the code instructions to cause the communication apparatus 1900 to perform the methods described in the above method embodiments.

The communication apparatus 1900 is a source secondary node: the transceiver 1905 performs step 201 in FIG. 2; step 301, step 302 and step 304 in FIG. 3, etc. The processor 1901 is used to perform step 303 in FIG. 3, etc.

The communication apparatus 1900 is a source master node: the transceiver 1905 is used to perform step 401 in FIG. 4; step 501 and step 502 in FIG. 5, etc.

The communication apparatus 1900 is a target secondary node: the transceiver 1905 is used to perform step 801 in FIG. 8; step 901, step 902 in FIG. 9, etc.

The communication apparatus 1900 is a target master node: the transceiver 1905 is used to perform step 1101 in FIG. 11; step 1201, step 1202 in FIG. 12, etc.

In one implementation, the processor 1901 may include a transceiver for implementing the receiving and transmitting functions. The transceiver may, for example, be a transceiver circuit, or an interface, or an interface circuit. The transceiver circuit, interface, or interface circuit for implementing the receiving and transmitting functions may be separate or may be integrated together. The transceiver circuit, interface, or interface circuit described above may be used for code/data reading and writing, or, the transceiver circuit, interface, or interface circuit described above may be used for signal transmission or delivery.

In one implementation, the processor 1901 may store a computer program 1903, which runs on the processor 1901 and may cause the communication apparatus 1900 to perform the methods described in the above method embodiments. The computer program 1903 may be solidified in the processor 1901, in which case, the processor 1901 may be implemented by hardware.

In one implementation, the communication apparatus 1900 may include a circuit, the circuit may implement the functions of transmitting or receiving or communicating in the foregoing method embodiments. The processors and transceivers described in this disclosure may be implemented in integrated circuits (ICs), analogue ICs, radio frequency integrated circuits RFICs, mixed signal ICs, application specific integrated circuits (ASICs), printed circuit boards (Printed circuit board (PCB), electronic devices, etc. The processor and transceiver can also be manufactured by various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), etc.

The communication apparatus in the above description of embodiments may be a network device, a terminal device, or an auxiliary communication device, but the scope of the communication apparatus described in the present disclosure is not limited thereto, and the structure of the communication apparatus may not be limited by FIG. 19. The communication apparatus may be a stand-alone device or may be part of a large device. For example, the described communication apparatus may be:
(1) a stand-alone integrated circuit IC, or chip, or, chip system or subsystem;
(2) a collection having one or more ICs, optionally, the collection of ICs may also include storage components for storing data, computer programs;
(3) ASIC, such as a modem;
(4) modules that can be embedded within other devices;
(5) receivers, terminal devices, smart terminal devices, cellular phones, wireless devices, handhelds, mobile units, in-vehicle devices, network devices, cloud devices, artificial intelligence devices, and the like;
(6) others, etc.

For the case where the communication apparatus may be a chip or a chip system, a schematic diagram of the structure of the chip shown in FIG. 20 may be referred to. The chip shown in FIG. 20 includes a processor 2001, a memory 2002 and an interface 2003. The number of processors 2001 may be one or more, and the number of interfaces 2003 may be more than one.

For the case where the chip is used to implement the functions of the source secondary node in an embodiment of the present disclosure:

The interface 2003 is used to perform step 201 in FIG. 2; step 301, step 302, and step 304 in FIG. 3, etc.; and the processor 2001 is used to perform step 303 in FIG. 3, etc.

For the case where the chip is used to implement the functions of the source master node in an embodiment of the present disclosure:
the interface 2003 is used to perform step 401 in FIG. 4, step 501, step 502 in FIG. 5, etc.

For the case where the chip is used to implement a function of a target secondary node in an embodiment of the present disclosure: the interface 2003 is used to perform step 801 in FIG. 8; step 901, step 902 in FIG. 9, etc.

For the case where the chip is used to implement a function of a target master node in an embodiment of the present disclosure:
the interface 2003 is used to perform step 1101 in FIG. 11; step 1201, step 1202 in FIG. 12, etc.

Optionally, the chip further includes a memory 2003, the memory 2003 is used to store necessary computer programs and data.

Those skilled in the art may also appreciate that the various illustrative logical blocks and steps listed in the embodiments of the present disclosure may be implemented by electronic hardware, computer software, or a combination of both. Whether such functionality is implemented by hardware or software depends on the particular application and the design requirements of the overall system. A person skilled in the art, for each particular application, may use various methods to implement the described functionality, but such implementations should not be construed as being going beyond the scope of protection of the embodiments of the present disclosure.

The present disclosure also provides a readable storage medium having stored thereon instructions which, when executed by a computer, implement the functionality of any of the method embodiments described above.

The present disclosure also provides a computer program product that realizes the functions of any of the above method embodiments when executed by a computer.

In the above embodiments, it may be achieved in whole or in part by software, hardware, firmware, or any combination thereof. When implemented using software, it may be implemented in whole or in part in the form of a computer program product. The computer program product includes one or more computer programs. Loading and executing the computer program on a computer produces, in whole or in part, generates a process or function in accordance with embodiments of the present disclosure. The computer may be a general purpose computer, a special purpose computer, a computer network, or other programmable devices. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fibre optic, digital subscriber line (DSL)) or wireless (e.g. infrared, wireless, microwave, etc.) to another website site, computer, server or data center. The computer-readable storage medium may be any usable medium to which a computer can be accessed or a data storage device such as a server, data center, etc. containing one or more integrated usable media. The usable medium may be a magnetic medium (e.g., floppy disk, hard disk, tape), an optical medium (e.g., a high-density digital video disc (DVD)), or a semiconductor medium (e.g., a solid state disk (SSD)), and the like.

A person of ordinary skill in the art may understand that the first, second, and other various numerical numbers involved in the present disclosure are only for the purpose of distinguishing for descriptive convenience, and are not used to limit the scope of the embodiments of the present disclosure, and also denote the order of precedence.

The at least one in the present disclosure may also be described as one or more, and the more may be two, three, four, or more, without limitation of the present disclosure. In embodiments of the present disclosure, for a technical feature, a technical feature is described by “first’, “second’, “third’, “A’, “B’, “C’, and “D’, etc., to differentiate technical features in the kind of technical features, the technical features described with “first’, “second’, “third’, “A’, “second’, “third’, “A’, “B’, A’, “B”, “B”, “C”, and “D” are not in any order of priority or magnitude.

The correspondence shown in each table in the present disclosure may be configured or may be predefined. The values of the information in the tables are only examples, and can be configured to other values, without limitation of the present disclosure. When configuring the correspondence between the information and respective parameters, it is not necessarily required that all of the correspondences illustrated in respective tables must be configured. For example, the correspondences illustrated in certain rows of the tables in the present disclosure may also not be configured. For another example, appropriate deformation adjustment can be made based on the above table, such as splitting, merging, and the like. The names of the parameters shown in the headings in the above-described tables may also be other names understandable by the communication apparatus, and the values or representations of the parameters thereof may also be other values or representations understandable by the communication apparatus. Each of the above tables may also be implemented using other data structures, for example, an array, a queue, a container, a stack, a linear table, a pointer, a chained list, a tree, a graph, a structure, a class, a heap, a hash table, may be used.

Predefined in the context of the present disclosure may be understood as defined, pre-defined, stored, pre-stored, pre-negotiated, pre-configured, cured, or pre-fired.

One of ordinary skill in the art may realize that the units and algorithmic steps of the various examples described in conjunction with the embodiments disclosed herein are capable of being implemented in electronic hardware, or a combination of computer software and electronic hardware. Whether these functions are performed in hardware or software depends on the particular application and design constraints of the technical solution. The skilled person may use different methods to implement the described functions for each particular application, but such implementations should not be considered going beyond the scope of the present disclosure.

It is clear to those skilled in the field to which it belongs that, for the convenience and brevity of the description, the specific working processes of the above-described systems, apparatuses, and units can be referred to the corresponding processes in the foregoing embodiments of the methods, which will not be repeated herein.

The above description is only a specific embodiment of the present disclosure, but the scope of protection of the present disclosure is not limited thereto, and any changes or substitutions that can be readily thought of by any person skilled in the art within the scope of technology disclosed in the present disclosure shall be covered within the scope of protection of the present disclosure. Therefore, the scope of protection of the present disclosure shall be subject to the scope of protection of the stated claims.

1. A method for updating a cell group of a dual connectivity terminal device, performed by a source secondary node, the method comprising:
sending a cell mobility procedure request message to a target node, wherein the request message is configured to instruct the target node to prepare a target candidate secondary cell group (SCG) for the dual connectivity terminal device, the target node is a target secondary node or a source master node.

2. The method according to claim 1, wherein the cell mobility procedure comprises at least one of the following:
a condition-based triggered mobility procedure, and a selective activation cell group procedure.

3. The method according to claim 1, wherein the target node is a target secondary node, the method further comprises:
receiving a feedback message sent by the target secondary node, wherein the feedback message is configured to indicate confirmation of acceptance of the cell mobility procedure request, or rejection of the cell mobility procedure request.

4. The method according to claim 3, further comprising:
determining a result corresponding to the cell mobility procedure based on the feedback message;
sending the result corresponding to the cell mobility procedure to a source master node.

5. A method for updating a cell group of a dual connectivity terminal device, performed by a source master node, the method comprising:
sending a cell mobility procedure request message to a target node in response to meeting a preset condition, wherein the request message is configured to instruct the target node to prepare a target candidate secondary cell group (SCG) and/or a target candidate master cell group (MCG) for the dual connectivity terminal device, the target node is a target master node or a target secondary node (SN).

6. The method according to claim 5, wherein the preset condition comprises any one of the following:
initiating a handover procedure;
initiating a SCG addition procedure;
initiating a SCG change procedure;
receiving a cell mobility procedure request message sent by a source secondary node;
receiving a result corresponding to the cell mobility procedure sent by the source secondary node, wherein the result corresponding to the cell mobility procedure is configured to indicate a feedback message of the target SN on the cell mobility procedure.

7. The method according to claim 5, wherein the target node is a target master node, the method further comprises:
receiving a feedback message sent by the target master node, wherein the feedback message is configured to indicate any of the following: acceptance of preparing the target candidate MCG, rejection of preparing the target candidate MCG, rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target candidate SCG but rejection of preparing the target candidate MCG.

8. The method according to claim 5, wherein the target node is a target secondary node and the cell mobility procedure is used for preparing the target candidate SCG, the method further comprises:
receiving a feedback message sent by the target secondary node, wherein the feedback message is configured to indicate rejection of preparing the target candidate SCG, or acceptance of preparing the target candidate SCG.

9. The method according to claim 5, wherein the cell mobility procedure comprises at least one of the following:
a condition-based triggered mobility procedure, and a selective activation cell group procedure.

10.-12. (canceled)

13. A method for updating a cell group of a dual connectivity terminal device, performed by a target master node, the method comprising:
receiving a cell mobility procedure request message sent by a source master node, wherein the request message is configured to instruct the target master node to prepare at least one of a target candidate secondary cell group (SCG) and/or a target candidate master cell group (MCG) for the dual connectivity terminal device.

14. The method according to claim 13, further comprising:
sending a cell mobility procedure request message to a target secondary node, wherein the request message is configured to instruct the target secondary node to prepare the target candidate SCG.

15. The method according to claim 14, further comprising:
receiving a feedback message sent by the target secondary node, wherein the feedback message is configured to indicate rejection of preparing the target candidate SCG, or acceptance of preparing the target candidate SCG.

16. The method according to claim 12, further comprising:
sending a feedback message to the source master node, wherein the feedback message is configured to indicate any of the following:
acceptance of preparing the target candidate MCG, rejection of preparing the target candidate MCG, rejection of preparing the target candidate MCG and the target candidate SCG, acceptance of preparing the target candidate MCG and the target candidate SCG, acceptance of preparing the target candidate MCG but rejection of preparing the target candidate SCG, acceptance of preparing the target candidate SCG but rejection of preparing the target candidate MCG.

17. The method according to claim 12, wherein the cell mobility procedure comprises at least one of the following:
a condition-based triggered mobility procedure, and a selective activation cell group procedure.

18. A communication apparatus, wherein the apparatus is configured in a source secondary node, the apparatus comprising:
a processor; and
a transceiver connected to the processor;
wherein the processor is configured to perform the method according to claim 1.

19.-21. (canceled)

22. A communication apparatus, wherein the apparatus is configured in a source master node, the apparatus comprises:
a processor; and
a transceiver connected to the processor;
wherein the processor is configured to perform the method according to claim 5.

23.-29. (canceled)

30. A communication apparatus, wherein the apparatus is configured in a target master node, the apparatus comprises:
a processor; and
a transceiver connected to the processor;
wherein the processor is configured to perform the method according to claim 13.

31.-38. (canceled)

39. A non-transitory computer-readable storage medium, for storing instructions, wherein the instructions cause the method according to claim 1 to be implemented when executed.

40. A non-transitory computer-readable storage medium, for storing instructions, wherein the instructions cause the method according to claim 5 to be implemented when executed.

41. A non-transitory computer-readable storage medium, for storing instructions, wherein the instructions cause the method according to claim 13 to be implemented when executed.
